(19) United States
(12) Patent Application Publication
(10) Pub. No.: US 2024/0357973 A1
(43) Pub. Date: Oct. 31, 2024

(54) POLE SAW WITH IMPROVED SPROCKET COVER

(71) Applicant: Milwaukee Electric Tool Corporation, Brookfield, WI (US)

(72) Inventor: Jordan Smith, Brookfield, WI (US)

(21) Appl. No.: 18/645,449

(22) Filed: Apr. 25, 2024

Related U.S. Application Data
(60) Provisional application No. 63/623,869, filed on Jan. 23, 2024.
(60) Provisional application No. 63/461,819, filed on Apr. 25, 2023.

(51) Int. Cl. A01G 3/08; B25F 5/02

(52) U.S. Cl. CPC A01G 3/086; B25F 5/02

(57) ABSTRACT

A pole saw is provided. The pole saw includes a housing including an electric motor, a work element, and a telescoping pole extending between the electric motor and the work element. The work element includes a bar supporting a cutting element, a sprocket driven by the electric motor and interfaced with the cutting element to drive the cutting element along the bar, and a work element housing disposed around the sprocket and a portion of the bar. The work element housing includes a sidewall and a peripheral wall extending about a periphery of the sidewall. The peripheral wall defines a bar opening through which the bar extends and a plurality of chip ejection ports spaced apart from one another and from the bar opening. All of the plurality of chip ejection ports are disposed on a same side of the bar.

### CROSS-REFERENCE TO RELATED APPLICATIONS

This application is a non-provisional application claiming the benefit of priority under 35 U.S.C. § 119 (e) to U.S. Provisional Application No. 63/461,819, filed on Apr. 25, 2023, and U.S. Provisional Application No. 63/623,869, filed Jan. 23, 2024, which are hereby incorporated by reference in their entirety.

### FIELD

The present disclosure relates generally to outdoor power tools, such as pole saws and telescoping pole saws.

### BACKGROUND

Pole tools, such as telescoping pole saws, eject debris during operation. For example, pole tools may eject chips during a cutting operation. Typically, pole tools eject such debris along a length of the pole tool towards an operator's hands and face, which is hazardous and may cause injury to the operator. Additionally, debris may be ejected towards the cutting element, which may damage and decrease performance of the cutting element.

Accordingly, improved pole tools having improved chip ejection are desired in the art. In particular, pole tools that eject debris or chips away from the operator and away from the cutting element would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a telescoping pole saw is provided. The telescoping pole saw includes a housing including an electric motor, a work element, and a telescoping pole extending between the electric motor and the work element. The work element includes a bar supporting a cutting element, a sprocket driven by the electric motor and interfaced with the cutting element to drive the cutting element along the bar, and a work element housing disposed around the sprocket and a portion of the bar. The work element housing includes a sidewall and a peripheral wall extending about a periphery of the sidewall. The peripheral wall defines a bar opening through which the bar extends and a plurality of chip ejection ports spaced apart from one another and from the bar opening. All of the plurality of chip ejection ports are disposed on a same side of the bar.

In accordance with another embodiment, a power tool is provided. The power tool includes a housing including an electric motor, a work element, and a driveshaft extending between the electric motor and the work element. The work element includes a bar supporting a cutting element, a sprocket driven by the electric motor and interfaced with the cutting element to drive the cutting element along the bar, and a work element housing disposed around the sprocket and a portion of the bar. The work element housing includes a sidewall and a peripheral wall extending about a periphery of the sidewall. The peripheral wall defines a bar opening through which the bar extends. A first distance between the cutting element and an interior surface of the peripheral wall adjacent the driveshaft is greater than 6 mm and a second distance between the cutting element and an interior surface the sidewall is greater than 7 mm.

In accordance with another embodiment, a method of operating a power tool is provided. The method includes providing a pole tool, positioning the work element of the pole tool in a desired position such that a longitudinal axis extending through the pole tool is at an angle relative to a surface, operating the pole tool such that the electric motor drives rotation of the cutting element, and ejecting debris from a plurality of chip ejection ports downward and toward the surface during the operating. The pole tool includes a housing including an electric motor, a work element, and a telescoping pole extending between the electric motor and the work element. The work element includes a bar supporting a cutting element, a sprocket driven by the electric motor and interfaced with the cutting element to drive the cutting element along the bar, and a work element housing disposed around the sprocket and a portion of the bar. The work element housing includes a sidewall and a peripheral wall extending about a periphery of the sidewall. The peripheral wall defines a bar opening through which the bar extends and the plurality of chip ejection ports spaced apart from one another and from the bar opening. All the plurality of chip ejection ports are disposed on a same side of the bar.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a pole saw in accordance with embodiments of the present disclosure;

FIG. 2A is a perspective view of a work element of the pole saw of FIG. 1 in accordance with embodiments of the present disclosure;

FIG. 2B is a perspective view of a work element of the pole saw of FIG. 1 in accordance with embodiments of the present disclosure;

FIG. 3A is a perspective view of a side of a work element housing of the work element of FIGS. 2A-2B in accordance with embodiments of the present disclosure;

FIG. 3B is a perspective view of another side of the work element housing of FIG. 3A in accordance with embodiments of the present disclosure;

FIG. 4A is a cross-section view of the work element of FIGS. 2A-2B in accordance with embodiments of the present disclosure;

FIG. 4B is a detailed view of the work element of FIG. 4A in accordance with embodiments of the present disclosure;

FIG. 4C is a detailed view of the work element of FIG. 4A in accordance with embodiments of the present disclosure;

FIG. 5A is a cross-section view of the work element of FIGS. 2A-2B along line V-V in accordance with embodiments of the present disclosure;

FIG. 5B is a detailed view of the work element of FIG. 5A in accordance with embodiments of the present disclosure;

FIG. 6A is a cross-section view of the work element of FIGS. 2A-2B along line VI-VI in accordance with embodiments of the present disclosure;

FIG. 6B is a detailed view of the work element of FIG. 6A in accordance with embodiments of the present disclosure;

FIG. 7A is a side, perspective view of a work element housing of the work element of FIGS. 2A-2B in accordance with embodiments of the present disclosure;

FIG. 7B is a bottom, perspective view of the work element housing of FIG. 7A in accordance with embodiments of the present disclosure;

FIG. 8 is a perspective view of a pole saw in accordance with embodiments of the present disclosure; and

FIG. 9 is a flow chart of a method of operating the pole saw of FIG. 1 in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, pole tools may eject debris or chips away from an operator of the pole tool and away from the cutting element of the pole tool. For example, the work element of the pole tool may eject chips downward towards a surface, such as the ground on which the operator stands. Ejecting chips in such a manner may provide greater user satisfaction because it may prevent injury to the operator. Additionally, ejecting chips downward away from the cutting element may prevent damage to and decreased performance of the cutting element.

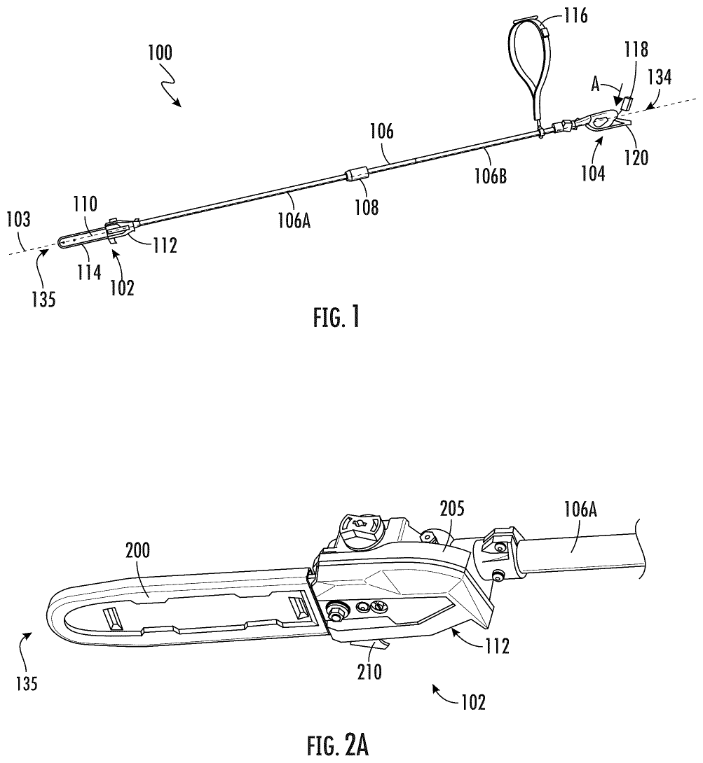

Referring now to the drawings, FIG. 1 illustrates a perspective view of a pole saw 100 in accordance with embodiments of the present disclosure.

In at least one example embodiment, the pole saw 100 extends along a longitudinal axis 103 between a first end, such as a rear end 134, and a second end, such as a front end 135. The pole saw 100 generally includes a work element 102, a housing 104, and a pole 106 extending between and connecting together the work element 102 and the housing 104. The housing 104 may be at the rear end 134 of the pole saw 100 and the work element 102 may be at the front end 135 opposite the rear end 134 of the pole saw 100.

In at least one example embodiment, the pole 106 is adjustable in length. For example, the pole 106 may be telescopic, including one or more segments 106A and 106B that telescopically move relative to one another. For example, the segment 106A may be an outer pole and the segment 106B may be an inner pole. In other example embodiments, the segment 106B may be the outer pole and segment 106A may be the inner pole. The inner pole may be configured to slide longitudinally within the outer pole between a retracted position and an extended position. An operator may adjust a distance between the work element 102 and the housing 104 by adjusting the relative positions of the segments 106A and 106B with respect to one another. For example, the operator may move the one or more segments 106A and 106B between the retracted position and the extended position. In at least one example embodiment, a lock or a clamp 108 may be used to maintain the segments 106A and 106B at relatively fixed positions with respect to one another.

In at least one example embodiment, the work element 102 of the pole saw 100 is a sawing tool configured to cut material. The sawing tool includes a bar 110 extending from a work element housing 112. A cutting element, such as a chain 114, extends in an infinite loop around the bar 110 and is driven to move along a track of the bar 110. While holding the pole saw 100 at the housing 104 and the pole 106, an operator can maneuver the sawing tool into position near an object, such as a branch, and urge the chain 114 into the object with the chain 114 in motion to cut the object. The operator can repeat this process as necessary. An optional shoulder or body strap 116 may be coupled to at least a portion of the pole saw 100. For example, the optional shoulder or body strap 116 may be coupled to a portion of the pole 106 adjacent the housing 104. The optional shoulder or body strap 116 may be used for prolonged use of the pole saw 100 to mitigate fatigue.

In at least one example embodiment, the chain 114 is driven by a motor. For example, the motor may be housed within the housing 104. A driveshaft can extend through the pole 106 to transfer power from the motor to the chain 114 through a chain sprocket. In other example embodiments, the motor may be housed within the work element housing 112 and drive the chain 114 through a chain sprocket.

In at least one example embodiment, the motor may be an electric motor, such as a direct current (DC) brushless motor. The motor includes an output shaft rotatably pinned to the chain sprocket, e.g., through a driveshaft. As the output shaft rotates, the chain 114 is driven within the track of the bar 110. In an example embodiment, the motor receives electrical power from a power source 118. For example, the power source 118 may include one or more batteries.

In at least one example embodiment, the pole saw 100 includes a receiving area 120 configured to receive the power source 118. For example, the receiving area 120 may be configured to receive one or more batteries, such as at least two batteries, at least three batteries, or even at least four batteries. In at least one example embodiment, the power source 118 may be installed in the receiving area 120 through a translational motion oriented in a direction shown by arrow A. In other example embodiments, the power source 118 may be installed in the receiving area 120 through a translational motion oriented in another direction, in a rotational motion, or in a translational-rotational motion.

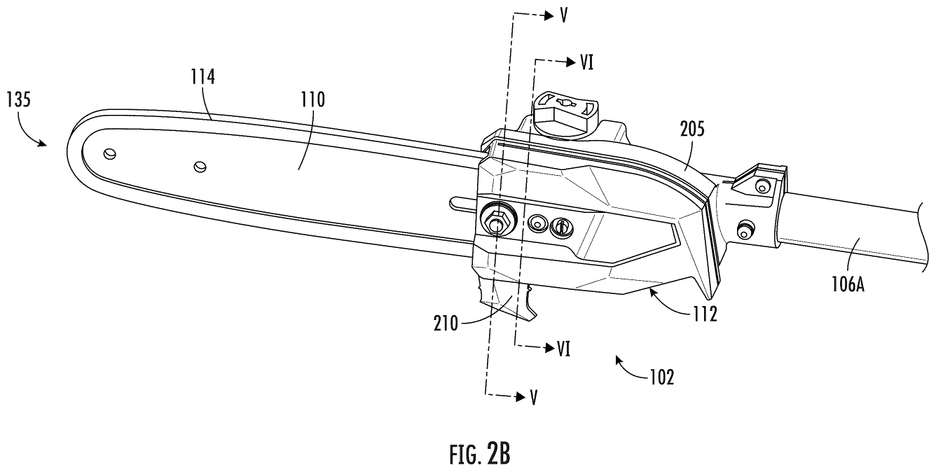

FIG. 2A illustrates a perspective view of the work element 102 of the pole saw 100 of FIG. 1 in accordance with embodiments of the present disclosure. FIG. 2B illustrates a perspective view of the work element 102 of the pole saw 100 of FIG. 1 in accordance with embodiments of the present disclosure.

In at least one example embodiment, the pole saw 100 may include a chain cover 200 configured to be disposed around the bar 110 and the chain 114. The chain cover 200 may prevent damage to the bar and chain 114 when the pole saw 100 is not in use, such as during transport of the pole saw 100. The chain cover 200 may also prevent damage to other objects and prevent injury to the operator when the pole saw 100 is not in use. Additionally, the chain cover 200 may be removed, as shown in FIG. 2B, to expose the bar 110 and the chain 114 prior to operation of the pole saw 100

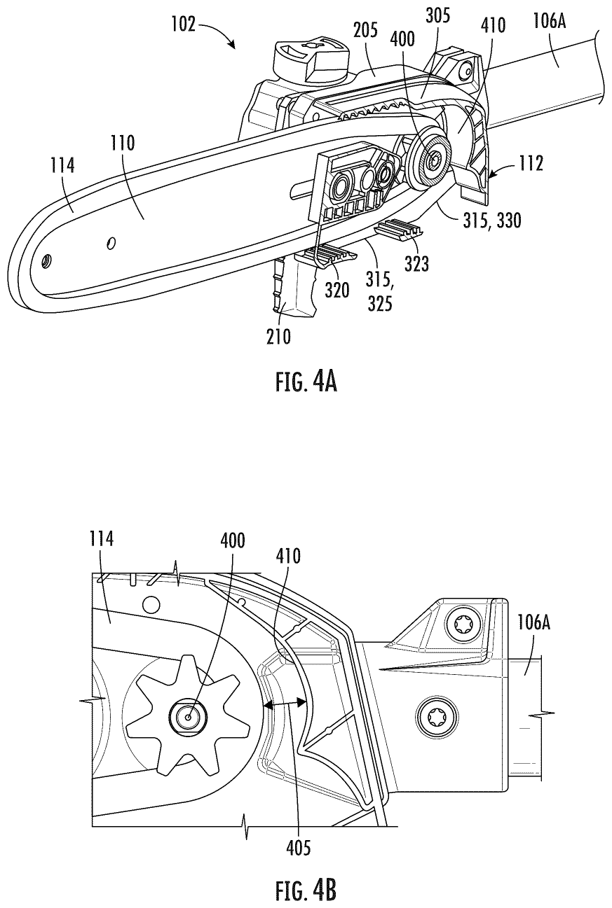

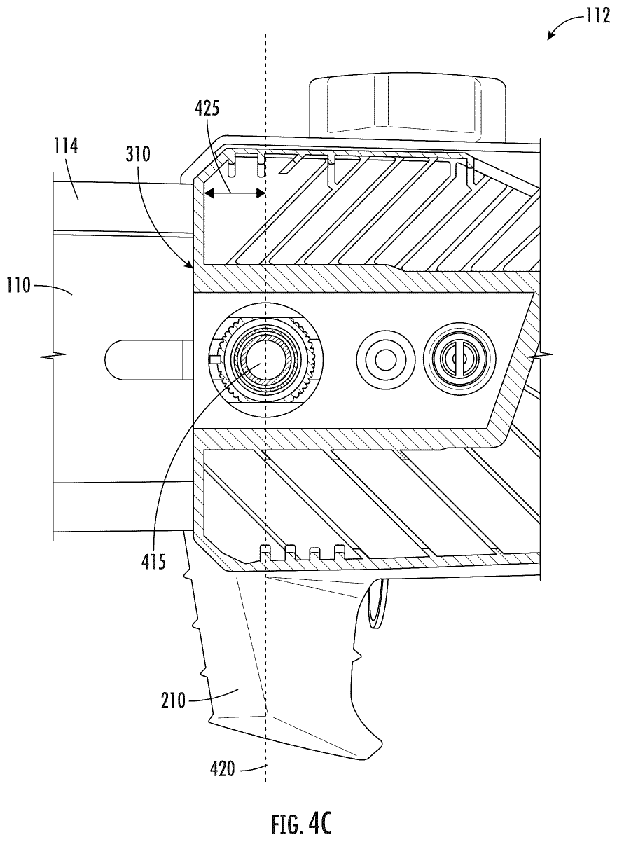

In at least one example embodiment, the pole saw 100 includes a base 205 coupled to the segment 106A of the pole 106 adjacent the front end 135. For example, the base 205 may couple the work element 102 to the pole 106. Additionally, the bar 110 may be coupled to the base 205, as will be discussed in greater detail with respect to FIGS. 4A-4C, below. At least a portion of the work element housing 112 is coupled to the base 205 such that the bar 110 and the chain 114 extend from the base 205 and the work element housing 112, as will also be discussed in greater detail with respect to FIGS. 4A-4C, below.

In at least one example embodiment, the base 205 includes a support 210 extending from an end of the base 205 adjacent the front end 135. The support 210 may be configured to help stabilize the pole saw 100 during operation. For example, the support 210 may be rested on a surface adjacent an object to be cut, such as a branch, to help stabilize the pole saw 100 during a cutting operation. Additionally, the support 210 may be configured to keep the bar 110 and the chain 114 raised above a surface, such as the ground, when not in use or during transportation of the pole saw 100.

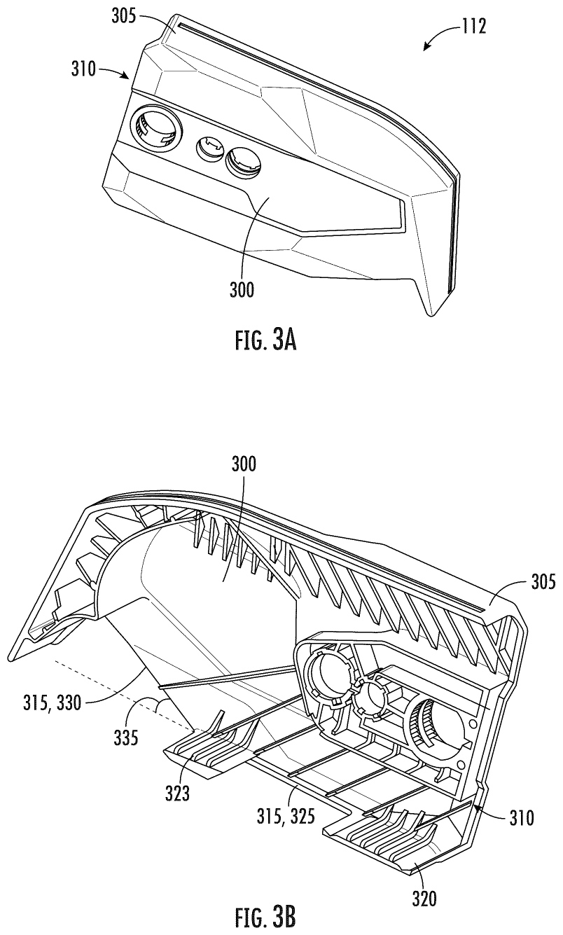

FIG. 3A illustrates a perspective view of a side of the work element housing 112 of the work element 102 of FIGS. 2A-2B in accordance with embodiments of the present disclosure. FIG. 3B illustrates a perspective view of another side of the work element housing 112 of FIG. 3A in accordance with embodiments of the present disclosure.

In at least one example embodiment, the work element housing 112 includes a sidewall 300 and a peripheral wall 305 extending about a periphery of the sidewall 300. The peripheral wall 305 defines a bar opening 310 through which at least a portion of the bar 110 and the chain 114 extend out of the work element housing 112. The bar opening 310 is adjacent the front end 135 of the pole saw 100.

In at least one example embodiment, the peripheral wall 305 defines a plurality of chip ejection ports 315. The plurality of chip ejection ports 315 may be spaced apart from one another and spaced apart from the bar opening 310. Additionally, each of the plurality of chip ejection ports 315 may be disposed on a same side of the bar 110.

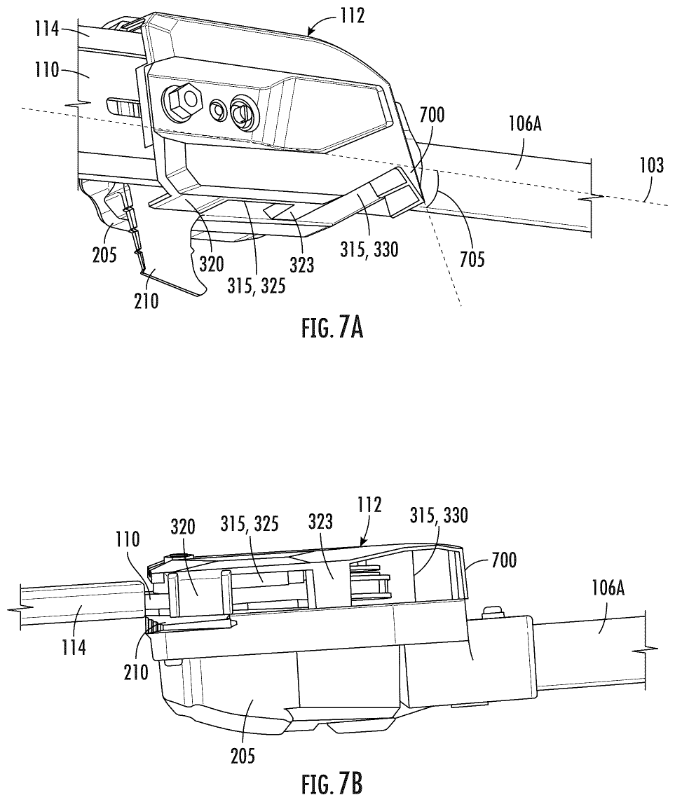

In at least one example embodiment, the plurality of chip ejection ports 315 includes at least two chip ejection ports. For example, the peripheral wall 305 of the work element housing 112 may define a first chip ejection port 325 and a second chip ejection port 330. The first chip ejection port 325 may be adjacent the bar opening 310 and the second chip ejection port 330 may be adjacent the pole 106. For example, the first chip ejection port 325 and the second chip ejection port 330 may be defined between portions of the peripheral wall 305, such as a first wall portion 320 and a second wall portion 323. In such example embodiments, the first wall portion 320 may be adjacent the bar opening 310 and the second wall portion 323 may be between the first chip ejection port 325 and the second chip ejection port 330. Additionally, the first chip ejection port 325, the second chip ejection port 330, the first wall portion 320, and the second wall portion 323 may be on a same side of the bar 110. Moreover, the support 210 may also be on the same side of the bar 110 as the first chip ejection port 325, the second chip ejection port 330, the first wall portion 320, and the second wall portion 323, as shown in FIGS. 4A and 7A-7B.

In at least one example embodiment, the first chip ejection port 325 has a first length and the second chip ejection port 330 has a second length. The second length of the second chip ejection port 330 may be greater than the first length of the first chip ejection port 325. Additionally, the first length of the first chip ejection port 325 and the second length of the second chip ejection port 330 may be greater than a length of each of the first wall portion 320 and the second wall portion 323. Moreover, the second chip ejection port 330 may extend at an angle 335 relative to the first chip ejection port 325.

FIG. 4A illustrates a cross-section view of the work element 102 of FIGS. 2A-2B in accordance with embodiments of the present disclosure. FIG. 4B illustrates a detailed view of the work element 102 of FIG. 4A in accordance with embodiments of the present disclosure. FIG. 4C illustrates a detailed view of the work element 102 of FIG. 4A in accordance with embodiments of the present disclosure.

In at least one example embodiment, the work element 102 includes a sprocket 400. The work element housing 112 is disposed around the sprocket 400 and at least a portion of the bar 110 and the chain 114. The sprocket 400 is configured to be driven by the electric motor and interfaced with the chain 114. For example, the electric motor rotates the sprocket 400 to drive the chain 114 along the bar 110.

In at least one example embodiment, the work element 102 includes a distance, such as a deflection distance 405, between the chain 114 and an inner surface 410 of the peripheral wall 305 of the work element housing 112. For example, the deflection distance 405 may be between the chain 114 and the inner surface 410 of the peripheral wall 305 of the work element housing 112 adjacent the segment 106A of the pole 106. In at least one example embodiment, the deflection distance 405 is greater than about 6 mm.

In at least one example embodiment, the work element 102 includes a fastener 415 configured to secure the bar 110 to the base 205. The fastener 415 may include a bolt, screw, or other fastener for securing the bar 110 to the base 205 of the work element 102. The fastener 415 may be adjacent the bar opening 310.

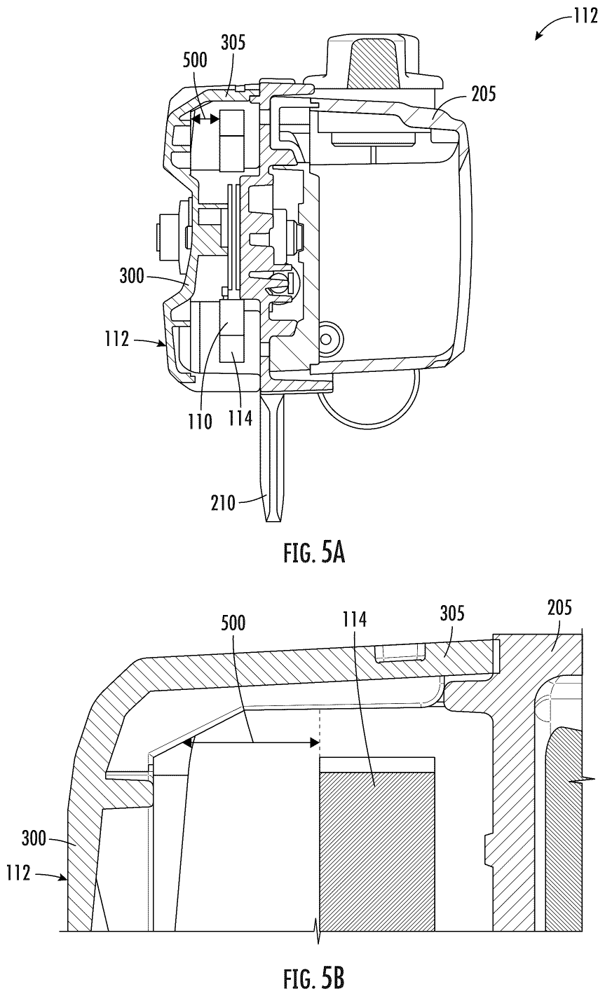

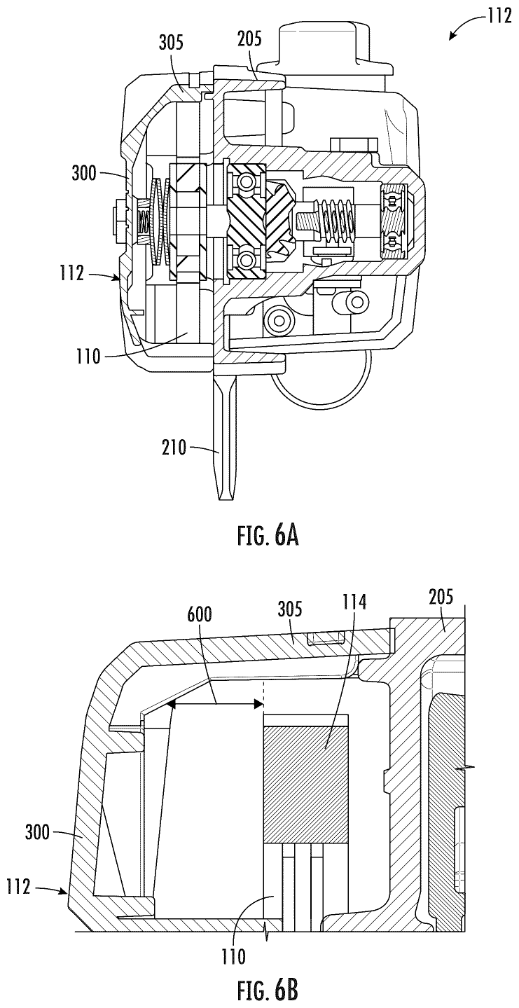

In at least one example embodiment, a fastener axis 420 extends vertically through a center of the fastener 415. For example, the fastener axis 420 extends perpendicular to the longitudinal axis 103 extending through the pole 106 of the pole saw 100. The work element 102 includes a segment 425 extending between the fastener axis 420 and the bar opening 310, which will be described in greater detail with respect to FIGS. 5A-6B, below. A length of the segment 425 may be about 14 mm in some example embodiments.

FIG. 5A illustrates a cross-section view of the work element 102 of FIGS. 2A-2B along line V-V in accordance with embodiments of the present disclosure. FIG. 5B illustrates a detailed view of the work element 102 of FIG. 5A in accordance with embodiments of the present disclosure.

In at least one example embodiment, the chain 114 is spaced from an interior surface of the sidewall 300 of the work element housing 112 a first sidewall distance 500 within the segment 425 (shown in FIG. 4C). For example, the first sidewall distance 500 is between an interior surface of the sidewall 300 and a surface of the chain 114 facing the sidewall 300. In at least one example embodiment, the first sidewall distance 500 is greater than about 7 mm within the segment 425. More specifically, the first sidewall distance 500 may be greater than about 8 mm within the segment 425. Additionally, the first sidewall distance 500 may be greater than about 8 mm for greater than or equal to about 70% of a length of the segment 425.

FIG. 6A illustrates a cross-section view of the work element 102 of FIGS. 2A-2B along line VI-VI in accordance with embodiments of the present disclosure. FIG. 6B illustrates a detailed view of the work element 102 of FIG. 6A in accordance with embodiments of the present disclosure.

In at least one example embodiment, the chain 114 is spaced from an interior surface of the sidewall 300 of the work element housing 112 a second sidewall distance 600 within the segment 425 (shown in FIG. 4C). For example, the second sidewall distance 600 is between an interior surface of the sidewall 300 and a surface of the chain 114 facing the sidewall 300. The second sidewall distance 600 may be closer to the bar opening 310 than the first sidewall distance 500. In at least one example embodiment, the second sidewall distance 600 is greater than about 7 mm within the segment 425. Additionally, the second sidewall distance 600 may be less than about 8 mm within the segment 425. Moreover, the second sidewall distance 600 may be less than about 8 mm for less than or equal to about 20% of the length of the segment 425.

FIG. 7A illustrates a side, perspective view of the work element housing 112 of the work element 102 of FIGS. 2A-2B in accordance with embodiments of the present disclosure. FIG. 7B illustrates a bottom, perspective view of the work element housing 112 of the work element 102 of FIG. 7A in accordance with embodiments of the present disclosure.

In at least one example embodiment, the work element housing 112 includes a guide portion 700 configured to direct debris through the plurality of chip ejection ports 315. For example, the peripheral wall 305 adjacent the segment 106A and the second chip ejection port 330 include the guide portion 700. The guide portion 700 may extend at an angle 705 relative to the longitudinal axis 103 extending through the pole 106 of the pole saw 100. Additionally, the second chip ejection port 330 may be at least partially defined between the guide portion 340 and the second wall portion 323.

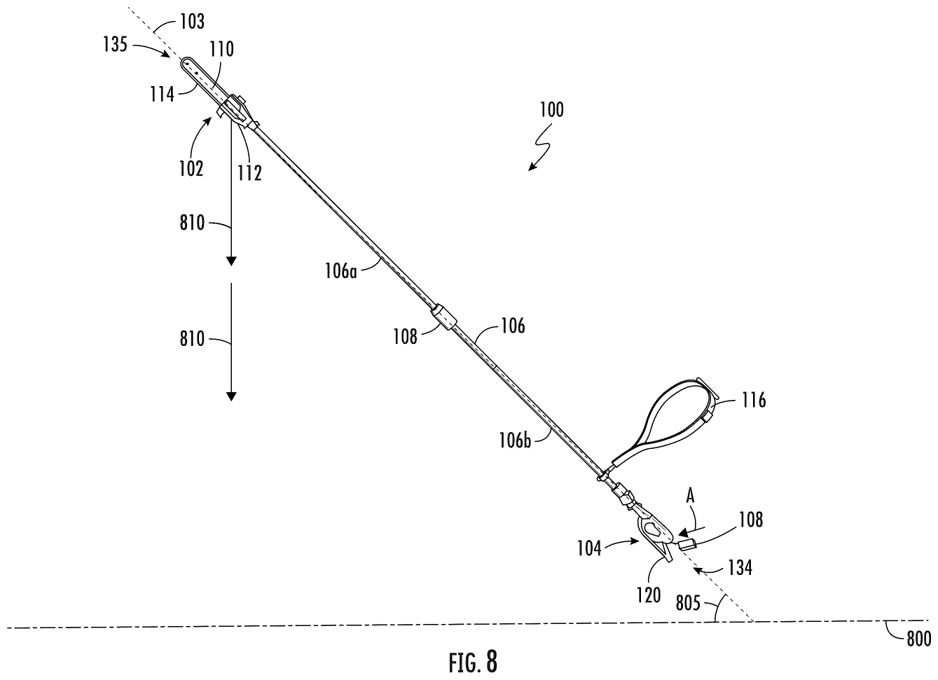

FIG. 8 illustrates a perspective view of the pole saw 100 in accordance with embodiments of the present disclosure.

In at least one example embodiment, the pole saw 100 may be positioned relative to a surface 800 by an operator (not shown) prior to use. For example, the pole saw 100 may be positioned at an angle 805 relative to the surface 800 and the longitudinal axis 103 extending through the pole saw 100. The surface 800 may include a surface, such as the ground, on which the operator of the pole saw 100 is positioned. In at least one example embodiment, the angle 805 may be less than or equal to about 90°. In other example embodiments, the angle 805 may be greater than about 90°.

In at least one example embodiment, the operator of the pole saw 100 positions the work element 102 of the pole saw near an object, such as a branch, for cutting. In such a position, the chain 114 of the pole saw 100 is urged into the object to cut the object when the chain 114 is in motion. The first wall portion 320, the second wall portion 323, and the guide portion 700 of the work element housing 112 direct the debris from the interior of the work element 102 through the plurality of chip ejection ports 315, such as the first chip ejection port 325 and the second chip ejection port 330. Debris from the object, such as wood chips from the branch, is directed downward from the plurality of chip ejection ports 315 toward the surface 800, as indicated by arrows 810.

In at least one example embodiment, the first wall portion 320, the second wall portion 323, and the guide portion 700 of the work element housing 112 prevent the debris from being ejected along the longitudinal axis 103. For example, the debris is directed downwards through the plurality of chip ejection ports 315, as indicated by the arrows 810, and away from the operator and the chain 114. Accordingly, the work element housing 112 of the pole saw 100 may prevent injury to the operator and may prevent damage to and decreased performance of the work element 102.

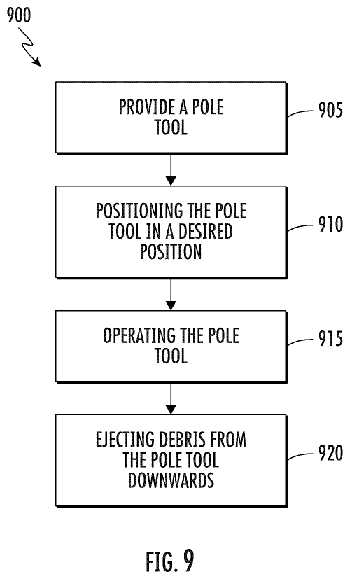

FIG. 9 illustrates a flow chart of a method of operating the pole saw 100 of FIG. 1 in accordance with embodiments of the present disclosure.

In at least one example embodiment, a method 900 of operating a power tool, such as the pole saw 100, includes providing a pole tool at 905, positioning the pole tool in a desired position at 910, operating the pole tool at 915, and ejecting debris from the pole tool downwards at 920.

In at least one example embodiment, providing the pole tool at 905 includes providing the pole saw 100, as shown in FIG. 1. The pole saw 100 includes the housing 104, the work element 102, and the pole 106 extending between the housing 104 and the work element 102. An electric motor may be disposed in the housing 104 or associated with the work element 102. The work element 102 includes the bar 110 supporting a cutting element, such as the chain 114. The work element 102 also includes the sprocket 400 configured to be driven by the electric motor and interfaced with the chain 114 to drive the chain 114 along the bar 110.

Additionally, the work element 102 includes the work element housing 112 disposed around the sprocket 400 and at least a portion of the bar 110. The work element housing 112 includes the sidewall 300 and the peripheral wall 305 extending about a periphery of the sidewall 300. The peripheral wall 305 of the work element housing 112 defines the bar opening 310 through which the bar 110 extends. The work element housing 112 also defines the plurality of chip ejection ports 315. Each of the plurality of the plurality of chip ejection ports 315 are disposed on a same side of the bar 110.

In at least one example embodiment, the positioning the pole tool in a desired position at 910 includes positioning the work element 102 of the pole saw 100 in a desired position such that the longitudinal axis 103 extending through the pole saw 100 is at the angle 805 relative to the surface 800. For example, the angle 805 may be the angle at which the operator positioned the pole saw 100 relative to the surface the operator is positioned. Additionally, the desired position of the pole saw 100 may be a position such that the work element 102 is nearby an object, such as a branch, to be cut by the chain 114 of the pole saw 100.

In at least one example embodiment, operating the pole tool at 915 includes operating the pole saw 100 such that the electric motor drives rotation of the chain 114. For example, the electric motor may drive rotation of the sprocket 400, which thereby drives rotation of the chain 114 about the bar 110. Rotation of the chain 114 about the bar 110 allows the object to be cut by the chain 114.

In at least one example embodiment, ejecting debris from the pole tool downwards at 920 includes ejecting debris from the plurality of chip ejection ports 315 downwards and toward the surface 800 during operation of the pole saw 100. For example, the debris within the work element 102 may be directed by the first wall portion 320, the second wall portion 323, and the guide portion 700 of the work element housing 112 through the plurality of chip ejection ports 315 and downward toward the surface 800, as indicated by the arrows 810 shown in FIG. 8.

Further aspects of the invention are provided by one or more of the following embodiments:

In accordance with one embodiment, a telescoping pole saw is provided. The telescoping pole saw includes a housing including an electric motor, a work element, and a telescoping pole extending between the electric motor and the work element. The work element includes a bar supporting a cutting element, a sprocket driven by the electric motor and interfaced with the cutting element to drive the cutting element along the bar, and a work element housing disposed around the sprocket and a portion of the bar. The work element housing includes a sidewall and a peripheral wall extending about a periphery of the sidewall. The peripheral wall defines a bar opening through which the bar extends and a plurality of chip ejection ports spaced apart from one another and from the bar opening. All of the plurality of chip ejection ports are disposed on a same side of the bar.

The telescoping pole saw of any one or more of the embodiments, wherein the plurality of chip ejection ports include a first chip ejection port adjacent the bar opening and a second chip ejection port adjacent the telescoping pole.

The telescoping pole saw of any one or more of the embodiments, wherein a length of the second chip ejection port is greater than a length of the first chip ejection port.

The telescoping pole saw of any one or more of the embodiments, wherein the second chip ejection port extends at an angle relative to the first chip ejection port.

The telescoping pole saw of any one or more of the embodiments, wherein the peripheral wall includes a first wall portion and a second wall portion on the same side of the bar as the first chip ejection port and the second chip ejection port. The first wall portion is adjacent the bar opening, and the second wall portion is between the first chip ejection port and the second chip ejection port.

The telescoping pole saw of any one or more of the embodiments, wherein a length of each of the first chip ejection port and the second chip ejection port is greater than a length of each of the first wall portion and the second wall portion.

The telescoping pole saw of any one or more of the embodiments, wherein the peripheral wall adjacent the telescoping pole includes a guide portion opposite the bar opening. The guide portion extends at an angle relative to a longitudinal axis extending though the telescoping pole and the guide portion is configured to direct debris through the plurality of chip ejection ports.

The telescoping pole saw of any one or more of the embodiments, further including a support extending from the work element adjacent the bar opening. The support is positioned on the same side of the bar as the plurality of chip ejection ports.

The telescoping pole saw of any one or more of the embodiments, wherein a first distance between the cutting element and an interior surface of the peripheral wall of the work element housing adjacent the telescoping pole is greater than 6 mm and a second distance between the cutting element and an interior surface of the sidewall of the housing cover is greater than 7 mm.

In accordance with another embodiment, a power tool is provided. The power tool includes a housing including an electric motor, a work element, and a driveshaft extending between the electric motor and the work element. The work element includes a bar supporting a cutting element, a sprocket driven by the electric motor and interfaced with the cutting element to drive the cutting element along the bar, and a work element housing disposed around the sprocket and a portion of the bar. The work element housing includes a sidewall and a peripheral wall extending about a periphery of the sidewall. The peripheral wall defines a bar opening through which the bar extends. A first distance between the cutting element and an interior surface of the peripheral wall adjacent the driveshaft is greater than 6 mm and a second distance between the cutting element and an interior surface the sidewall is greater than 7 mm.

The power tool of any one or more of the embodiments, wherein the work element housing includes a fastener configured to secure the bar to the work element. The fastener is adjacent the bar opening. The work element housing defines a segment between a fastener axis extending through a center of the fastener and the bar opening. The fastener axis is perpendicular to a longitudinal axis extending through the driveshaft.

The power tool of any one or more of the embodiments, wherein the second distance is greater than 8 mm for greater than or equal to 70% of the segment and the second distance is less than 8 mm for greater than or equal to 20% of the segment.

The power tool of any one or more of the embodiments, wherein the peripheral wall of the housing cover of the work element housing defines a plurality of chip ejection ports. All of the plurality of chip ejection ports are disposed on a same side of the bar and spaced apart from one another between the bar opening and the driveshaft.

The power tool of any one or more of the embodiments, further including a support extending from the work element adjacent the bar opening. The support is positioned on the same side of the bar as the plurality of chip ejection ports.

The power tool of any one or more of the embodiments, wherein the plurality of chip ejection ports include a first chip ejection port adjacent the bar opening and a second chip ejection port adjacent the driveshaft.

The power tool of any one or more of the embodiments, wherein a length of the second chip ejection port is greater than a length of the first chip ejection port and the second chip ejection port extends at an angle relative to the first chip ejection port.

The power tool of any one or more of the embodiments, wherein the peripheral wall includes a first wall portion and a second wall portion on the same side of the bar as the first chip ejection port and the second chip ejection port. The first wall portion is adjacent the bar opening, and the second wall portion is between the first chip ejection port and the second chip ejection port.

The power tool of any one or more of the embodiments, wherein a length of each of the first chip ejection port and the second chip ejection port is greater than a length of each of the first wall portion and the second wall portion.

The power tool of any one or more of the embodiments, wherein the peripheral wall adjacent the driveshaft includes a guide portion opposite the bar opening. The guide portion extends at an angle relative to a longitudinal axis extending though the driveshaft and the guide portion is configured to direct debris through the plurality of chip ejection ports.

In accordance with another embodiment, a method of operating a power tool is provided. The method includes providing a pole tool, positioning the work element of the pole tool in a desired position such that a longitudinal axis extending through the pole tool is at an angle relative to a surface, operating the pole tool such that the electric motor drives rotation of the cutting element, and ejecting debris from a plurality of chip ejection ports downward and toward the surface during the operating. The pole tool includes a housing including an electric motor, a work element, and a telescoping pole extending between the electric motor and the work element. The work element includes a bar supporting a cutting element, a sprocket driven by the electric motor and interfaced with the cutting element to drive the cutting element along the bar, and a work element housing disposed around the sprocket and a portion of the bar. The work element housing includes a sidewall and a peripheral wall extending about a periphery of the sidewall. The peripheral wall defines a bar opening through which the bar extends and the plurality of chip ejection ports spaced apart from one another and from the bar opening. All the plurality of chip ejection ports are disposed on a same side of the bar.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A telescoping pole saw, comprising:
a housing including an electric motor;
a work element comprising:
a bar supporting a cutting element,
a sprocket driven by the electric motor and interfaced with the cutting element to drive the cutting element along the bar,
a work element housing disposed around the sprocket and a portion of the bar, the work element housing including a sidewall and a peripheral wall extending about a periphery of the sidewall, wherein the peripheral wall defines:
a bar opening through which the bar extends, and
a plurality of chip ejection ports spaced apart from one another and from the bar opening, wherein all of the plurality of chip ejection ports are disposed on a same side of the bar; and
a telescoping pole extending between the electric motor and the work element.

2. The telescoping pole saw of claim 1, wherein the plurality of chip ejection ports comprise:
a first chip ejection port adjacent the bar opening; and
a second chip ejection port adjacent the telescoping pole.

3. The telescoping pole saw of claim 2, wherein a length of the second chip ejection port is greater than a length of the first chip ejection port.

4. The telescoping pole saw of claim 2, wherein the second chip ejection port extends at an angle relative to the first chip ejection port.

5. The telescoping pole saw of claim 2, wherein:
the peripheral wall includes a first wall portion and a second wall portion on the same side of the bar as the first chip ejection port and the second chip ejection port;
the first wall portion is adjacent the bar opening; and
the second wall portion is between the first chip ejection port and the second chip ejection port.

6. The telescoping pole saw of claim 5, wherein a length of each of the first chip ejection port and the second chip ejection port is greater than a length of each of the first wall portion and the second wall portion.

7. The telescoping pole saw of claim 1, wherein:
the peripheral wall adjacent the telescoping pole includes a guide portion opposite the bar opening;
the guide portion extending at an angle relative to a longitudinal axis extending though the telescoping pole; and
the guide portion is configured to direct debris through the plurality of chip ejection ports.

8. The telescoping pole saw of claim 1, further comprising a support extending from the work element adjacent the bar opening, wherein the support is positioned on the same side of the bar as the plurality of chip ejection ports.

9. The telescoping pole saw of claim 1, wherein:
a first distance between the cutting element and an interior surface of the peripheral wall of the work element housing adjacent the telescoping pole is greater than 6 mm; and
a second distance between the cutting element and an interior surface of the sidewall of the housing cover is greater than 7 mm.

10. A power tool comprising:
a housing including an electric motor;
a work element comprising:
a bar supporting a cutting element,
a sprocket driven by the electric motor and interfaced with the cutting element to drive the cutting element along the bar,
a work element housing disposed around the sprocket and a portion of the bar, the work element housing including a sidewall and a peripheral wall extending about a periphery of the sidewall, the peripheral wall defining a bar opening through which the bar extends; and
a driveshaft extending between the electric motor and the work element;
wherein a first distance between the cutting element and an interior surface of the peripheral wall adjacent the driveshaft is greater than 6 mm; and
wherein a second distance between the cutting element and an interior surface the sidewall is greater than 7 mm.

11. The power tool of claim 10, wherein:
the work element housing comprises a fastener configured to secure the bar to the work element, the fastener adjacent the bar opening; and
the work element housing defines a segment between a fastener axis extending through a center of the fastener and the bar opening, the fastener axis perpendicular to a longitudinal axis extending through the driveshaft.

12. The power tool of claim 11, wherein:
the second distance is greater than 8 mm for greater than or equal to 70% of the segment; and
the second distance is less than 8 mm for greater than or equal to 20% of the segment.

13. The power tool of claim 10, wherein the peripheral wall of the housing cover of the work element housing defines a plurality of chip ejection ports, all of the plurality of chip ejection ports are disposed on a same side of the bar and spaced apart from one another between the bar opening and the driveshaft.

14. The power tool of claim 13, further comprising a support extending from the work element adjacent the bar opening, wherein the support is positioned on the same side of the bar as the plurality of chip ejection ports.

15. The power tool of claim 13, wherein the plurality of chip ejection ports comprise:
a first chip ejection port adjacent the bar opening; and
a second chip ejection port adjacent the driveshaft.

16. The power tool of claim 15, wherein:
a length of the second chip ejection port is greater than a length of the first chip ejection port; and
the second chip ejection port extends at an angle relative to the first chip ejection port.

17. The power tool of claim 15, wherein:
the peripheral wall includes a first wall portion and a second wall portion on the same side of the bar as the first chip ejection port and the second chip ejection port;
the first wall portion is adjacent the bar opening; and
the second wall portion is between the first chip ejection port and the second chip ejection port.

18. The power tool of claim 17, wherein a length of each of the first chip ejection port and the second chip ejection port is greater than a length of each of the first wall portion and the second wall portion.

19. The power tool of claim 13, wherein:
the peripheral wall adjacent the driveshaft includes a guide portion opposite the bar opening;
the guide portion extending at an angle relative to a longitudinal axis extending though the driveshaft; and
the guide portion is configured to direct debris through the plurality of chip ejection ports.

20. A method of operating a power tool, comprising:
providing a pole tool, the pole tool comprising:
a housing including an electric motor,
a work element comprising:
a bar supporting a cutting element,
a sprocket driven by the electric motor and interfaced with the cutting element to drive the cutting element along the bar,
a work element housing disposed around the sprocket and a portion of the bar, the work element housing including a sidewall and a peripheral wall extending about a periphery of the sidewall, wherein the peripheral wall defines:
a bar opening through which the bar extends, and
a plurality of chip ejection ports spaced apart from one another and from the bar opening, wherein all the plurality of chip ejection ports are disposed on a same side of the bar, and
a telescoping pole extending between the electric motor and the work element;
positioning the work element of the pole tool in a desired position such that a longitudinal axis extending through the pole tool is at an angle relative to a surface;
operating the pole tool such that the electric motor drives rotation of the cutting element; and
ejecting debris from the plurality of chip ejection ports downward and toward the surface during the operating.
